(19) United States
(12) Patent Application Publication
(10) Pub. No.: US 2018/0018682 A1
(43) Pub. Date: Jan. 18, 2018

(54) Devices, Frameworks and Methodologies Configured to Enable Automated Monitoring and Analysis of Dwell Time

(71) Applicant: University of Technology Sydney, Broadway, NSW (AU)

(72) Inventors: Nathan Kirchner, Broadway (AU); Michelle Zeibots, Broadway (AU); Alen Alempijevic, Broadway (AU)

(73) Assignee: University of Technology Sydney, Broadway, NSW (AU)

(21) Appl. No.: 15/548,876

(22) PCT Filed: Feb. 8, 2016
(86) PCT No.: PCT/AU2016/000034

§ 371 Date: Aug. 4, 2017

(30) Foreign Application Priority Data
Feb. 6, 2015 (AU) 2015900381

(51) Int. Cl. G06Q 30/02; G06Q 50/30

(52) U.S. Cl. CPC G06Q 30/0201; G06Q 50/30

(57) ABSTRACT

Described herein are devices, frameworks and methodologies configured to enable monitoring and analysis of dwell time in respect of a human conveyance. Embodiments of the invention have been particularly developed for monitoring and analysis of dwell time in respect of trains. In some examples, the technology makes use of depth-sensitive sensor equipment to monitor activity in three dimensions, including train and passenger and activity, thereby to identify artefacts of dwell time events.

### FIELD OF THE INVENTION

The present invention relates to devices, frameworks and methodologies configured to enable automated monitoring and analysis of dwell time, for example dwell time in respect of a human conveyance. Embodiments of the invention have been particularly developed for monitoring and analysis of dwell time in respect of trains. While some embodiments will be described herein with particular reference to that application, it will be appreciated that the invention is not limited to such a field of use, and is applicable in broader contexts. For example, the technology disclosed is equally and readily applicable to other human conveyances, including buses, elevators, and the like, and in some cases technology described herein finds even wider application in contexts other than human conveyances.

### BACKGROUND

Any discussion of the background art throughout the specification should in no way be considered as an admission that such art is widely known or forms part of common general knowledge in the field.

Various attempts have been made to monitor the performance of train systems, for example to analyse efficiencies (and inefficiencies) and identify factors responsible for delays. An important observable factor is the amount of time a train spends at a station, and this is often measured in a rudimental manner by a human observer by way of a stopwatch.

### SUMMARY OF THE INVENTION

It is an object of the present invention to overcome or ameliorate at least one of the disadvantages of the prior art, or to provide a useful alternative.

One embodiment provides a computer implemented method for analysing dwell time in respect of a human conveyance, the method including:

receiving data derived from one or more activity sensing units, wherein the activity sensing units include one or more sensors configured to provide three dimensional depth data;

processing the received data based on a set of one or more processing algorithms, thereby to identify dwell event artefacts, wherein each dwell event artefact relates to an activity observed in the received data, including one or more dwell event artefacts identified using processing of data representative of movement of objects in three dimensions derived from the one or more sensors configured to provide three dimensional depth data;

processing the dwell event artefacts thereby to define one or more dwell events, including at least one dwell event defined based a dwell event artefact identified using processing of data representative of movement of objects in three dimensions derived from the one or more sensors configured to provide three dimensional depth data;

updating a dwell event database, thereby to store data that relates each set of dwell event artefacts with its associated dwell event; and

executing a reporting module that is configured to provide report data derived from the dwell event database.

One embodiment provides a computer implemented method wherein the report data includes report data representative of representative of (i) core passenger movements; and (ii) opportunistic passenger movements.

One embodiment provides a computer implemented method wherein the dwell event artefacts include one or more dwell event artefacts derived from data representing passenger activity and/or timing data associated with passenger activity, wherein the data representing passenger activity is derived from the one or more sensors configured to provide three dimensional depth data.

One embodiment provides a computer implemented method wherein the one or more dwell event artefacts derived from data representing passenger activity include one or more dwell event artefacts representative of (i) core passenger movements; and (ii) opportunistic passenger movements.

One embodiment provides a computer implemented method wherein the dwell event artefacts include data representing passenger activity and/or timing data associated with passenger activity.

One embodiment provides a computer implemented method wherein passenger activity includes any one or more of: passenger movement; passenger demographic categorisation; passenger density; passenger throughput; passenger movement directions; and abnormal passenger behaviours.

One embodiment provides a computer implemented method wherein processing the dwell event artefacts thereby to define one or more dwell events includes: processing the dwell event artefacts thereby to define a given dwell event by determining a set of dwell event artefacts that collectively define that dwell event.

One embodiment provides a computer implemented method wherein the dwell event artefacts include data representing conveyance activity and/or timing data associated with conveyance activity, including one or more of: conveyance position; conveyance velocity; conveyance door status; conveyance door movement characteristics; and conveyance visual attributes.

One embodiment provides a computer implemented method wherein the dwell event artefacts include data representing passenger activity and/or timing data associated with passenger activity, wherein the data representing passenger activity is derived from the one or more sensors configured to provide three dimensional depth data.

One embodiment provides a computer implemented method wherein one or more dwell event artefacts are reconciled against a maintenance alert log.

One embodiment provides a computer implemented method for analysing dwell time in respect of a human conveyance, the method including:

receiving data derived from one or more activity sensing units;

processing the received data based on a set of one or more processing algorithms, thereby to identify dwell event artefacts, wherein each dwell event artefact relates to an activity observed in the received data;

processing the dwell event artefacts thereby to define one or more dwell events;

updating a dwell event database, thereby to store data that relates each set of dwell event artefacts with its associated dwell event; and

executing a reporting module that is configured to provide report data derived from the dwell event database.

One embodiment provides a computer implemented method including, for each dwell event, determining a set of dwell event artefacts that are associated with that dwell event.

One embodiment provides a computer implemented method wherein processing the dwell event artefacts thereby to define one or more dwell events includes: processing the dwell event artefacts thereby to define a given dwell event by determining a set of dwell event artefacts that collectively define that dwell event.

One embodiment provides a computer implemented method wherein the set of dwell event artefacts that collectively define that dwell event include: a first dwell event artefact that defines a start time for the dwell event; and a second dwell event artefact that defines a finish time for the dwell event.

One embodiment provides a computer implemented method including a subsequent step of associating one or more further dwell event artefacts with a defined dwell event.

One embodiment provides a computer implemented method wherein the set of one or more processing algorithms include algorithms configured to perform any one or more of the following: (i) identify presence and/or movement of an object having defined characteristics; (ii) categorise an object based on attributes of its activity; and (iii) identify prescribed action types based on activities of an object.

One embodiment provides a computer implemented method wherein determining a set of dwell event artefacts that are associated with a given dwell event includes applying a set of dwell time processing rules.

One embodiment provides a computer implemented method wherein the one or more activity sensing devices are configured to sense movement of objects in three dimensions.

One embodiment provides a computer implemented method wherein the dwell event artefacts include data representing conveyance activity and/or timing data associated with conveyance activity.

One embodiment provides a computer implemented method wherein conveyance activity includes any one or more of: conveyance position; conveyance velocity; conveyance door status; conveyance door movement characteristics; and conveyance visual attributes.

One embodiment provides a computer implemented method wherein the dwell event artefacts include data representing passenger activity and/or timing data associated with passenger activity.

One embodiment provides a computer implemented method wherein passenger activity includes any one or more of: passenger movement; passenger demographic categorisation; passenger density; passenger throughput; passenger movement directions; and abnormal passenger behaviours.

One embodiment provides a computer implemented method wherein the data received from the one or more activity sensing units additionally includes audio data, and wherein one or more dwell event artefacts are defined based on the received audio data.

One embodiment provides a computer implemented method including receiving data from one or more further data sources, wherein one or more dwell event artefacts are defined based on the data received from the one or more further data sources.

One embodiment provides a computer implemented method wherein the report includes (i) report data derived from the dwell event database; and (ii) data derived from the one or more further data sources.

One embodiment provides a computer implemented method wherein the one or more further data sources include one or more of: a source of ticket sales data; a source of additional passenger monitoring data; a source of data from one or more additional sensor devices.

One embodiment provides a computer implemented method for analysing dwell time in respect of an object, the method including:

receiving data derived from one or more activity sensing units;

maintaining access to a repository of dwell-time processing rules;

processing the received data based on one or more of the dwell time processing rules, thereby to:
(i) define individual dwell events;
(ii) for each dwell event, define a set of dwell event artefacts; and
(iii) update a dwell event database, thereby to store data that associates each set of dwell event artefacts with a particular dwell event; and

execute a reporting module that is configured to provide report data derived from the dwell event database.

One embodiment provides a computer program product for performing a method as described herein.

One embodiment provides a non-transitory carrier medium for carrying computer executable code that, when executed on a processor, causes the processor to perform a method as described herein.

One embodiment provides a system configured for performing a method as described herein.

Reference throughout this specification to “one embodiment”, “some embodiments” or “an embodiment” means that a particular feature, structure or characteristic described in connection with the embodiment is included in at least one embodiment of the present invention. Thus, appearances of the phrases “in one embodiment”, “in some embodiments” or “in an embodiment” in various places throughout this specification are not necessarily all referring to the same embodiment, but may. Furthermore, the particular features, structures or characteristics may be combined in any suitable manner, as would be apparent to one of ordinary skill in the art from this disclosure, in one or more embodiments.

As used herein, unless otherwise specified the use of the ordinal adjectives “first”, “second”, “third”, etc., to describe a common object, merely indicate that different instances of like objects are being referred to, and are not intended to imply that the objects so described must be in a given sequence, either temporally, spatially, in ranking, or in any other manner.

In the claims below and the description herein, any one of the terms comprising, comprised of or which comprises is an open term that means including at least the elements/features that follow, but not excluding others. Thus, the term comprising, when used in the claims, should not be interpreted as being limitative to the means or elements or steps listed thereafter. For example, the scope of the expression a device comprising A and B should not be limited to devices consisting only of elements A and B. Any one of the terms including or which includes or that includes as used herein is also an open term that also means including at least the elements/features that follow the term, but not excluding others. Thus, including is synonymous with and means comprising.

As used herein, the term “exemplary” is used in the sense of providing examples, as opposed to indicating quality. That is, an “exemplary embodiment” is an embodiment provided as an example, as opposed to necessarily being an embodiment of exemplary quality.

### BRIEF DESCRIPTION OF THE DRAWINGS

Embodiments of the invention will now be described, by way of example only, with reference to the accompanying drawings in which:

FIG. 1A schematically illustrates a framework according to one embodiment.

FIG. 1B schematically illustrates a framework according to one embodiment.

FIG. 1C schematically illustrates a framework according to one embodiment.

FIG. 2 illustrates a method according to one embodiment.

FIG. 3 illustrates a rendering of a generated report according to one embodiment.

FIG. 4A provides an expanded view of dwell event details shown in FIG. 3.

FIG. 4B provides an expanded view of historical average details shown in FIG. 3.

FIG. 5 illustrates comparative statistical distributions relating to dwell time effects.

### DETAILED DESCRIPTION

Described herein are devices, frameworks and methodologies configured to enable monitoring and analysis of dwell time in respect of a human conveyance. Embodiments of the invention have been particularly developed for monitoring and analysis of dwell time in respect of trains. While some embodiments will be described herein with particular reference to that application, it will be appreciated that the invention is not limited to such a field of use, and is applicable in broader contexts. For example, the technology disclosed is equally and readily applicable to other human conveyances, including buses, elevators, and the like, and in some cases technology described herein finds even wider application in contexts other than human conveyances.

### The Concept of Dwell Time

Embodiments discussed herein relate to the concept of “dwell time”, and more specifically to monitoring and/or analysis of dwell time.

The concept of “dwell time”, as described herein in the context of a human conveyance, relates to the timing of a process whereby a human conveyance stops (or slows) to enable the boarding and/or de-boarding of passengers. For example, this may include trains stopping at stations, buses stopping at bus stops, elevators stopping at floors in a building, ski lifts which include low-speed zones in stations, and so on.

The disclosure herein described “dwell time” by reference to “dwell events”. In this regard, the term “dwell event” describes an event that is defined relative to commencement and completion of a specific instance of dwell time.

The precise definition of dwell time (and hence dwell events) varies from instance-to-instance, depending on subjective preferences for a specific implementation. For example, in the case of a train, in some embodiments dwell time is defined by reference to period of time during which a train is stationary, in other embodiments by reference to period of time during which a train enters a station zone, and in other by reference to period of time between commencement of deceleration approaching a station and completion of re-acceleration having left a station. It will be appreciated that particular dwell time definitions enable respective aspects of data that are able to be monitored and/or analysed.

Dwell time is a major factor in train operations. Specifically, the safety requirement of a minimum headway (typically specified in operating Standards) between trains is vulnerable to the dwell time (for instance, time taken for passengers to board/de-board), and the variance of this time. For example, if passengers on train A take a longer than typical time to board then the following train B would need to completely stop so as to not violate this minimum headway safety requirement.

Furthermore, reducing the dwell time (for example through reducing the average boarding/de-boarding time and/or the variance of the average boarding/de-boarding time) will allow operators to reduce the factor of safety in their operating headways. This subsequently enables additional train paths through the system on the existing infrastructure; this is a significant cost saver. For example, it has been estimated that a single additional train path across the Harbour Bridge in Sydney is worth $50M per annum.

Embodiments of the technology disclosed herein are in some instances applied thereby to enable a postponement additional infrastructure works by allowing additional train paths to be realised on the existing infrastructure.

### Dwell Time Monitoring and Analysis

Various technologies described herein provide computer implemented methods for automated analysing of dwell time in respect of a human conveyance (and hardware configured to enable the performance of such methods.

One such method includes receiving data derived from one or more “activity sensing” units, which provide “activity sensing data”. Activity sensing data is representative of activity in a sensed area, which is preferably determined using one or more forms of sensor, including sensors configured to sense three dimensional depth data. In preferred embodiments these include sensors configured to track the location and/or movement of objects (which may include humans and other objects) in three dimensions. For example, some embodiments utilise 3D scanner systems that implement light coding, or other variants of image-based 3D reconstruction. For example, appropriate sensors include those available via Xbox Kinect and ASUS XTION hardware. These provide 3D RGBD Depth Images, which are suitable for analysis of activity and motion as discussed herein.

One or more activity sensing units are mounted in locations where they can monitor activity of a human conveyance (or in some embodiments another object or region). For example, examples provided herein focus on application of the technology in the context of monitoring dwell times for trains at train stations; in such a situation a preferred approach is to mount one or more of the sensing units in a platform area (for example to posts, walls, ceilings, or the like), with sensors positioned to observe platform areas including one or more regions at which train doors are likely to be positioned when a train is stationary at the platform.

Data collected by the senor units is in some embodiments subjected to a degree of pre-processing by software executing on a processor at the sensor unit. In other embodiments the data is transferred in a raw form. In any case, a processing device, for example an analysis server, is configured to process data from one or more of the sensing units thereby to enable generation of data relating to dwell time.

Data collected by the sensing units may include additional data beyond activity sensing data. For example, in some embodiments audio data, image data, smart phone proximity data and other forms of observable data are also captured. Furthermore, data collected by the sensing units is in some embodiments supplemented by additional forms of data from further data sources, including the likes of ticketing systems, control systems, other sensor units, and so on. It will be appreciated that a wide range of additional data is in various embodiments collected to supplement activity sensing data.

As described further below, processing algorithms are configured to analyse data derived from activity sensing units, thereby to identify prescribed forms of motion. These may include any one or more of: prescribed motion of a train (or other conveyance); prescribed motion of a component of a train (or other conveyance), such as prescribed motion of a door; and prescribed motion characteristics of objects predicted to be humans. That is, using motion analysis algorithms defined via known techniques, a computing system is configured to identify, from sensing data, details of train and human activity.

In a preferred embodiment an analysis server is configured to maintain access to a repository of dwell-time processing rules. These rules enable identification of various artefacts in data derived from activity sensing. For example, the rules may relate to:
Identifying particular conveyance activity. By way of example, “conveyance activity” includes any one or more of: conveyance position; conveyance velocity; conveyance door status; conveyance door movement characteristics; and conveyance visual attributes. For instance, a rule may be defined to enable automated recognition of a train door from activity sensing data, and automated recognition and diagnosis of movement of that train door.
Identifying particular passenger activity. By way of example, “passenger activity” includes any one or more: passenger movement; passenger demographic categorisation; passenger density; passenger throughput; passenger movement directions; and abnormal passenger behaviours (for example categorisation of “core” and “opportunistic” behaviours). For example, software is configured to enable automated identification of passengers, and rules are configured to identify and categorise particular movement/behaviour artefacts, such as falling, dropping an object, moving is defined manners, entering/existing a train, sitting, standing, etc.

The term “passenger” is used to describe persons (or presumed “persons”) observed by an activity sensing unit. It will be appreciated that not all “passengers” need actually be passengers of a conveyance in practice; they may include (for instance) a person who is located on a train platform, but who never boards a train.

Received data, including activity sensing data, is processing on one or more of the dwell time processing rules. This processing results in the defining of individual dwell events. As an example, in the context of monitoring trains, a dwell event is in general terms defined by events relating to a given train's pause at a given station. The processing additionally results in, for each dwell event, defining of a set of dwell event artefacts. A dwell event database is updated, thereby to store data that associates each set of dwell event artefacts with a particular dwell event.

In a preferred embodiment, the dwell time processing rules operate to enable identification of particular dwell event artefacts for a given dwell event, and data representing these artefacts is associated with the dwell event in a database. For example, in one embodiment each dwell artefact is defined by a set of data including some or all of the following:
A dwell event identifier. This uniquely identifies a dwell event to which the dwell event artefact relates).
An artefact type. This is associated with a descriptor and/or other information that allows an operator to understand the nature of the artefact. For example, artefacts may include events such a door opening, a train arrival, a person falling over, and so on. Artefacts may also include measurements, such as boarding throughput at a given door, number of passengers on a platform, and so on. Artefacts may also include individual observed items, such as passengers (which may be classified based on passenger classification algorithms), objects left on the platform, animals, and so on.
Timing information. This may include start/stop times, a single event time, and/or an event duration.
Artefact values. This provides deeper data describing the artefact. For example, in the case of a door opening artefact, the artefact values may include a number of boarding passengers and a number of de-boarding passengers.

The precise nature of data recorded for each dwell event artefact is defined by the dwell time processing rules.

A reporting module is configured to provide report data derived from the dwell event database. For example, in some embodiments a report provides details of dwell time for a dwell event, and one or more artefacts of that dwell event. In some embodiments the report enables a user to drill down into more detailed data thereby to view artefact details that are not displayed in a high level report.

### Exemplary Frameworks

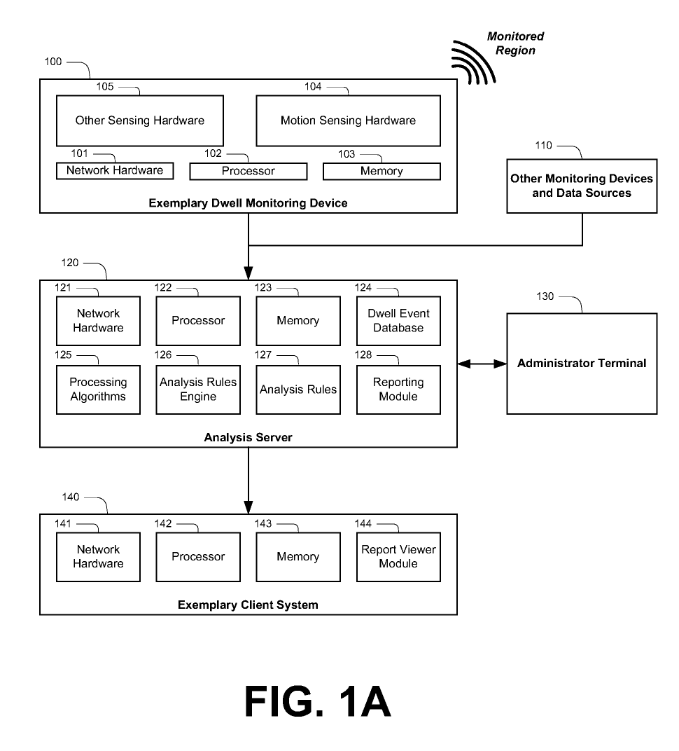

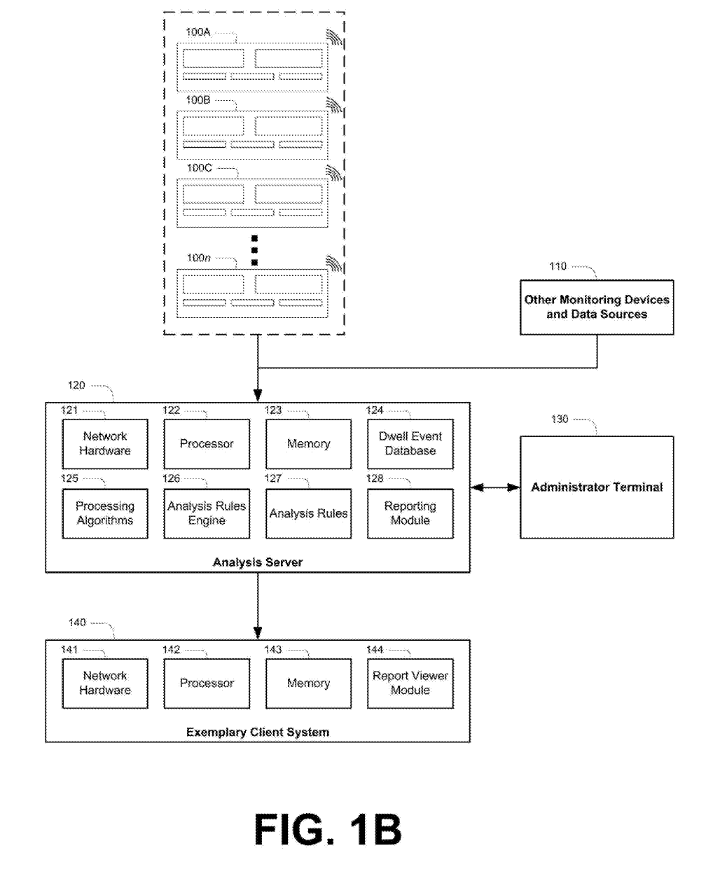

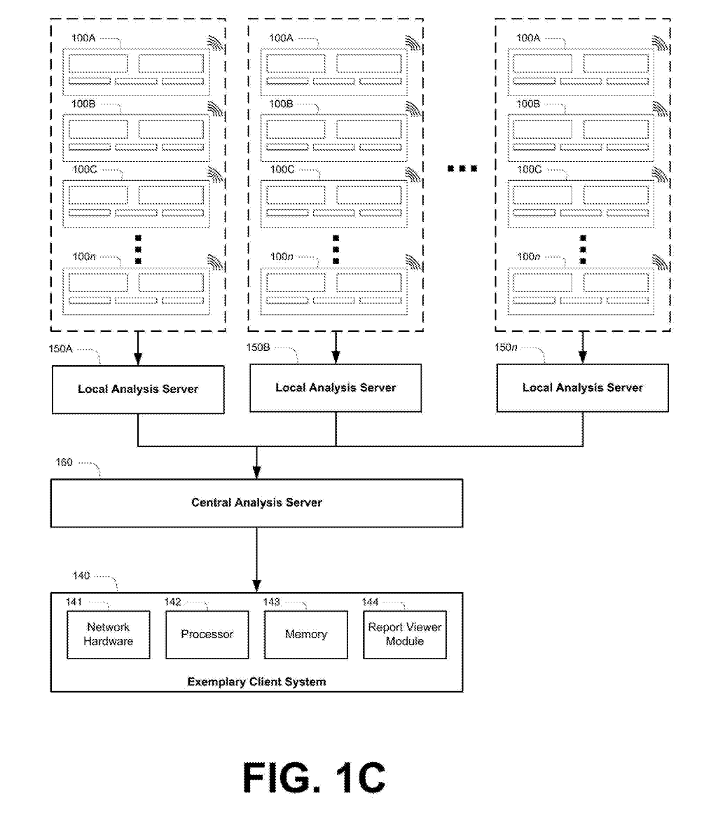

FIG. 1A to FIG. 10 illustrate frameworks according to exemplary embodiments.

FIG. 1A illustrates an exemplary Dwell Monitoring Device 100. Device 100 includes computing and monitoring components contained in a secure enclosure, which is mounted to a structure proximal a monitored region (for example a region of a train station platform). Device 100 includes network hardware 101 (for example a WiFi or Ethernet port) which allows the Device to communicate with other devices. A processor 102 allows the execution of computer readable code (software instructions) maintained on a memory device 103. This configures Device 100 to operate activity sensing hardware 104 (for example a camera and infrared projector) and other sensing hardware (for example a microphone or other audio sensor devices).

It will be appreciated that Device 100 provides a simplified view of hardware, and other graphics cards and the like may be present. For example, in some embodiments Device 100 includes hardware and software configured to run activity sensing hardware provided by an Xbox Kinect (or other such activity sensing device). By way of example, appropriate sensors include those available via Xbox Kinect and ASUS XTION hardware. These provide 3D RGBD Depth Images, which are suitable for analysis of activity and motion as discussed herein.

Device 100 is coupled to an analysis server 120. Analysis server 120 additionally receives input from other monitoring devices and/or data sources 110, which may include the likes of ticketing systems, turnstiles, timetable databases, security cameras, network signalling, manual input from station/train staff, and so on. Server 120 is responsible for processing the received data thereby to determine dwell time data, and from that allow the generation of dwell time reporting data.

Server 120 includes network hardware 121, a processor 122 and memory 123. Various functionally distinguishable components are also illustrated. These include:
Processing algorithms 125. This includes a set of algorithms that are configured to perform automated identification, categorisation and monitoring of objects in activity sensing data. The set of algorithms is able to be expanded over time thereby to enhance functionality. For example, a specific algorithm may be defined to identify and monitor a particular movement aspects associated with a given form of conveyance. Examples of algorithms include algorithms to identify trains, doors, persons, falls, dropped items, a train arriving, passenger interference with door operation, door and station alignment, station/train staff signalling, and so on.
An analysis rules engine 126. This is configured to execute a plurality of analysis rules, which act on data made available by the processing algorithms.
Analysis rules 127. As noted, these are executed by an analysis rules engine, and include rules for defining dwell events and dwell event artefacts based on output of algorithms that analysis activity sensing data (and/or other data available to the analytics server). Rules may be defined using general logic, for example “IF, “THEN” and “ELSE” operators. For example “IF new train identified by Algorithm A, THEN create new Dwell event ID AND THEN identify Train Stop Time AND THEN record Train Stop Time with Dwell event ID in Dwell Event Database”. In some embodiments the rules are defined probabilistically. For example, since a new train was identified by Algorithm A AND passengers are entering it THEN the doors must be open even though that was not observable THEREFORE record Train Door Open Time with Dwell event ID in Dwell Event Database.
A dwell event database 124. This records data defining dwell event artefacts, based on the execution of rules by the rules engine.
A Reporting module 128. This is configured to enable the generation and provision of reporting data utilising the dwell event database. For example, reports may be generated to show dwell times, passenger statistics for dwell events, timing of events during dwell events, and so on.

An administrator terminal 130 is configured to interact with server 120, thereby to enable the customisation of rules, algorithms and/or reporting functionalities.

An exemplary client system 140 includes network hardware 141, a processor 142 and memory 143. Client system 140 provides a report viewer module (which may be provided by, for example, code stored locally, or via code obtained from a remote sever and rendered locally in a web browser application). This report viewer module interacts with reporting module 128 thereby to allow the requesting and rendering of report data at client system 140.

In the example of FIG. 1B, multiple monitoring devices (100A to 100n) are coupled to a common analysis server 120. For example, this is in some embodiments applied in the context of multiple monitoring units spaced along a train platform.

In the example of FIG. 1C, multiple sets of monitoring units each communicate with a respective local analysis server (which may be a server such as server 120), and these all communicate with a central analysis server 160. This, for example, allows an arrangement such as that of FIG. 1B to be implemented in respect of a given train platform, and for data across a plurality of stations to be collated thereby to allow for centralised monitoring and analysis of dwell times.

In some embodiments, the processing algorithms are configured to enable categorisation of passengers based on their activities (which are able to be objectively determined from activity sensing). For example, by assessing body position and/or movement characteristics, each observed “person” in activity sensing data is placed into one of a set of categories. In one embodiment, the categories are: Business, Tourist, and Normal. These are defined by reference to observable characteristics of movement and/or standing pose.

### Exemplary Dwell Time Reports

An exemplary dwell time report for a train is shown in table form below:

DWELL TIME REPORT: TRAIN X AT PLATFORM Y

| | |
|---|---|
| Train Arrived | 10:00:18 |
| Doors Opened | 10:00:20 |
| Passenger Flow Commence | 10:01:22 |
| Passenger Flow Finished | 10:01:38 |
| Doors Closed | 10:01:54 |
| Train Departed | 10:01:55 |
| Dwell Time (total) | 00:01:37 |
| Dwell Time (doors open) | 00:01:34 |

In one embodiment, a report such as that shown above is generated by way of activity sensing data alone. Rules are defined for analysing image data thereby to determine timing information for the following artefacts: Train Arrived (for example based on activity sensing data that identifies a train achieving a stationary position), Doors Opened (for example based on activity sensing data that identifies a door commencing opening operation), Doors Closed (for example based on activity sensing data that identifies a door completing opening operation), and Train Departed (for example based on activity sensing data that identifies a train commencing movement).

A more detailed report is shown in table form below. This includes various additional artefacts based on algorithms configured to identify and categorise passenger movements.

DWELL TIME REPORT: TRAIN X AT PLATFORM Y
Scheduled 10:00 Arrival

| | | |
|---|---|---|
| Train Movement | Train Arrived | 10:00:18 |
| | Doors Opened | 10:00:20 |
| | Whistle Sounded | 10:01:50 |
| | Doors Closed | 10:01:54 |
| | Train Departed | 10:01:55 |
| Dwell Time | Dwell Time (total) | 00:01:37 |
| | Dwell Time (doors open) | 00:01:34 |
| Passenger Throughput | Total Boarding | 34 |
| | Total De-Boarding | 46 |
| | Boarding: Door 1 | 3 |
| | Boarding: Door 2 | 5 |
| | Boarding: Door 3 | 1 |
| | Boarding: Door 4 | 15 |
| | Boarding: Door 5 | 10 |
| | De-Boarding: Door 1 | 6 |
| | De-Boarding: Door 2 | 12 |
| | De-Boarding: Door 3 | 14 |
| | De-Boarding: Door 4 | 18 |
| | De-Boarding: Door 5 | 4 |
| Passenger Demographics | Total | 80 |
| | Business | 40 |
| | Normal | 29 |
| | Tourist | 11 |
| Passenger Events | Falls | 0 |
| | Dropped Items | 3 |
| | Blocking Doors | 1 |
| | Suspect Behaviour | 0 |

It will be observed that this report includes an artefact “Whistle Sounded” which is, in some embodiments, derived from audio data as opposed to activity sensing data (however it will be appreciated that algorithms are in some cases used to identify such an event based on motion-based monitoring of human activity). The report above additionally includes artefacts derived from monitoring movement of passengers relative to train doors (boarding and de-boarding numbers), passenger demographics (derived from, by way of example, activity sensing based categorisation, as discussed above), and events such as falls and passengers blocking doors (which are observable based on particular processing algorithms.

### Exemplary Method

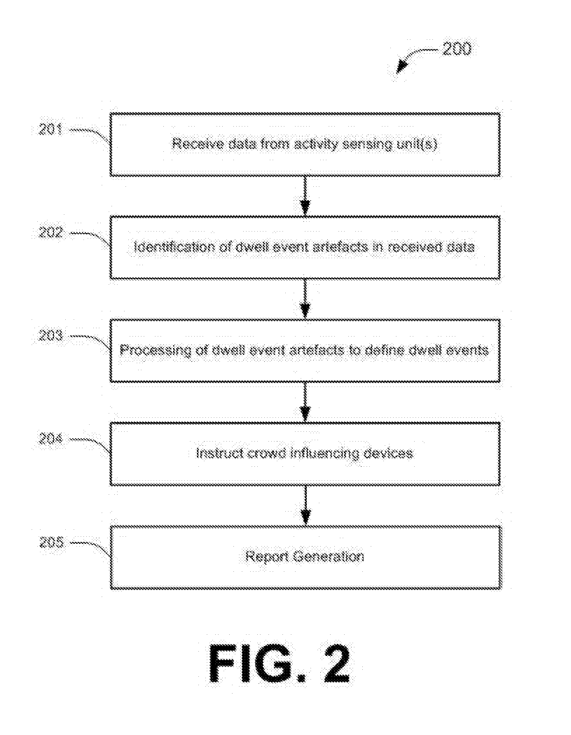

FIG. 2 illustrates a method 200 according to one embodiment. This is a computer implemented method for analysing dwell time in respect of a human conveyance.

Functional block 201 represents a process including receiving data derived from one or more activity sensing units. In some embodiments there is a single unit. In some embodiments there are multiple units monitoring a common zone (for example a train platform). In some embodiments there are multiple units monitoring multiple distinct zones (for example multiple train platforms).

Functional block 202 represents a process including processing the received data based on a set of one or more processing algorithms, thereby to identify dwell event artefacts. Each dwell event artefact relates to an activity observed in the received data. For example, in some embodiments algorithms are identified, created and/or modified to allow automated determination of particular types of dwell time artefacts in raw data.

Functional block 203 represents a process including processing the dwell event artefacts thereby to define one or more dwell events. For example, this may include determining a set of dwell event artefacts that are associated with that dwell event. In some embodiments processing the dwell event artefacts thereby to define one or more dwell events includes: processing the dwell event artefacts thereby to define a given dwell event by determining a set of dwell event artefacts that collectively define that dwell event. For example the set of dwell event artefacts that collectively define the relevant dwell event include: a first dwell event artefact that defines a start time for the dwell event; and a second dwell event artefact that defines a finish time for the dwell event.

Functional block 204 represents a process including updating a dwell event database, thereby to store data that relates each set of dwell event artefacts with its associated dwell event.

Functional block 204 represents a process including executing a reporting module that is configured to provide report data derived from the dwell event database.

In some cases the method includes a subsequent step of associating one or more further dwell event artefacts with a defined dwell event. For example, additional rules and/or algorithms may be applied in respect of previously processed data, such that additional knowledge of a dwell event is able to be extracted. By way of example, an algorithm may be developed for identifying persons with guide dogs, and this retrospectively applied to historical data thereby to analyse instances where such persons had an influence of dwell times.

### Exemplary Report

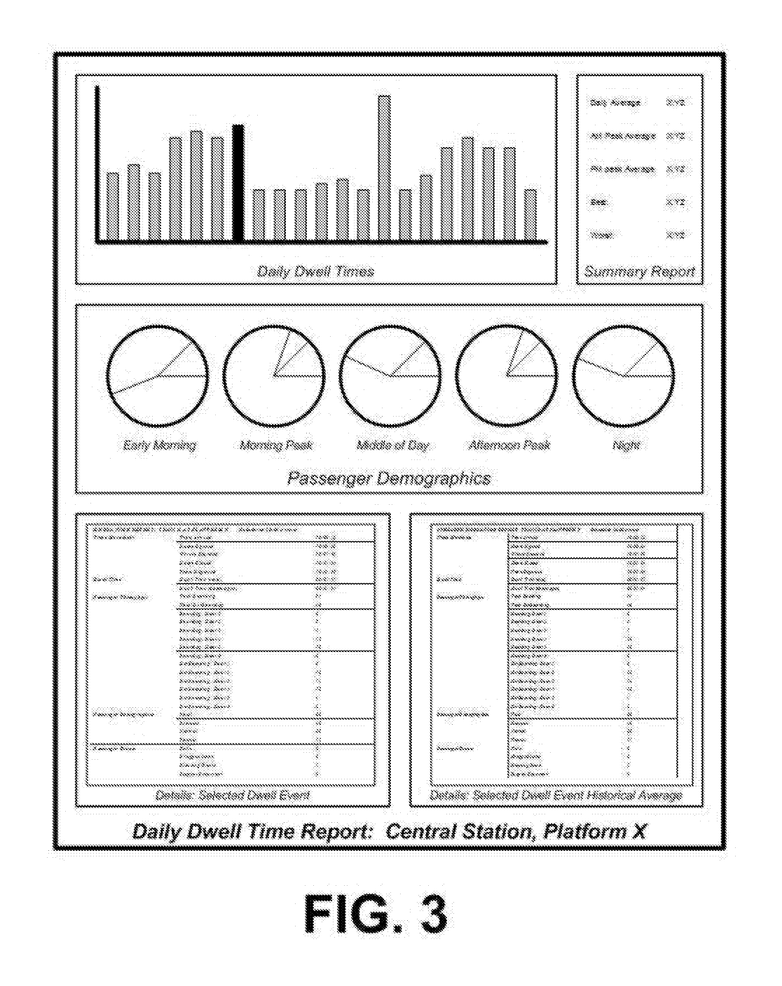

FIG. 3 illustrates an exemplary rendering of a dwell time report according to one embodiment. It will be appreciated that the precise nature of reports (for example in terms of information contained, presentation, interactive nature, purpose, and so on) varies between embodiments. The illustration of FIG. 3 is provided to enable a skilled addressee with familiarity in report generation techniques to understand various ways in which the technology described herein may be applied in the context of reporting.

The example of FIG. 3 includes a bar chart that shows dwell times for a 24-hour period, for trains at a particular platform of a particular station. Each bar in the chart represents a dwell time instance in the form of a train stopping to board and de-board passengers. It will be appreciated that in another embodiment each bar may be an average for trains over a given time period (for example one bar per hour, or the like).

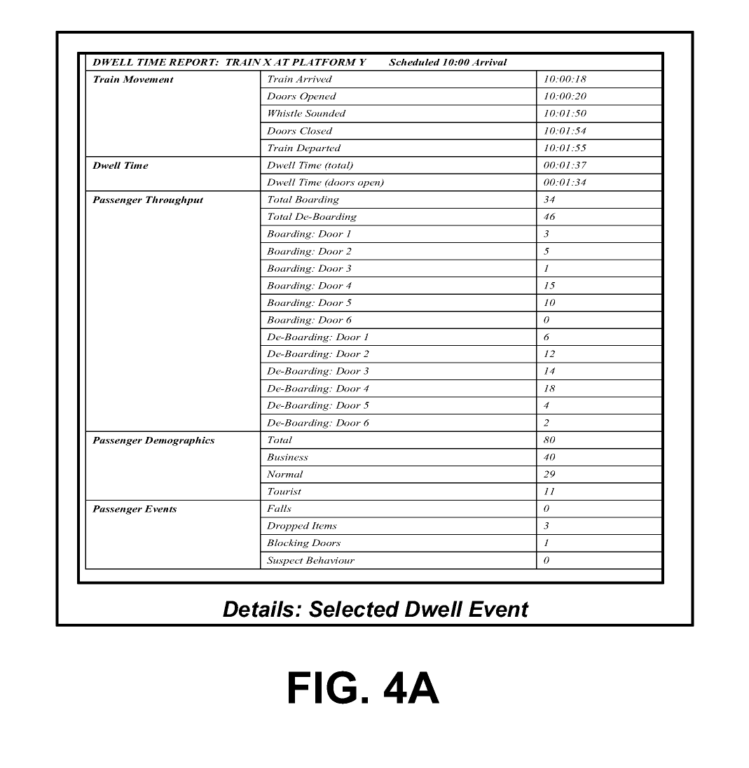

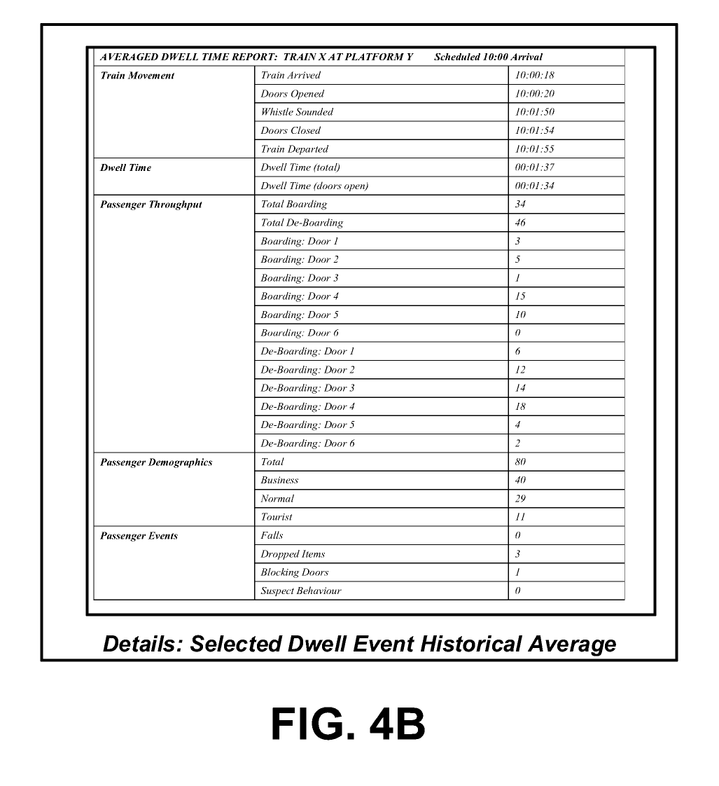

The illustrated report is interactive (for example it is displayed in a web page, based on data provided by a web server, with the server configured to respond to user interactions with objects defined on the page). Specifically, a user is enabled to select a particular one of the bars, and receive more detailed information with respect to that dwell event. In this case, the more detailed information includes a table such as shown further above in the specification, which provides numerical information describing dwell time artefacts for the dwell event. A second table is also shown, this providing historical averages for a defined period in respect of the same dwell event (as defined from a daily perspective). This allows a viewer to quickly identify factors that may have been responsible for deviation from average. This may be used for subsequent optimisation or the like. It will be appreciated that data in these tables is not intended to accurately represent any particular real world situation. The tables of FIG. 3 are expanded for clearer viewing in FIG. 4A and FIG. 4B.

A summary report is also provided for the day, showing average dwell time for the day and peak periods, along with best and worst dwell times. The “best” and “worst” fields are preferably interactive, thereby to enable selection of the relevant events and display of detailed information for those events.

A series of pie charts are also provided, showing passenger demographics at various times of day (for example based on “business”, “normal” and “tourist” categorisations disclosed further above). It will be appreciated that pie charts may be used for various other purposes as well (for example breaking down an individual dwell event into time-consuming portions).

It will be appreciated that a wide range of other reports are used in embodiments, including reports relating to particular trains, stations, networks, individual events, weekly period, yearly periods, and so on. Persons familiar with data analysis and reporting techniques will appreciate how information in a database such as dwell event database 124 enables a wide range of reports to be coded and generated.

### Alternate Passenger Categorisations: Core and Opportunistic Movements

In examples above, passengers are categorised based on demographics, using motion-based categorisation algorithms. In further embodiments, passenger movements are alternately/additionally categorised based on passenger typologies and/or movement characteristics.

In one example, passengers (or their movements) are categorised as being either “core” or “opportunistic”. The term “core” is used to describe routine passenger movements, for example where a passenger awaits an oncoming conveyance in an ordinary pose and/or position, and enters the conveyance in an expected ordinary manner (for example in a direction and rate that is consistent with surrounding passengers). The “core” designation may also be used to describe the movement of a cluster of proximal passengers. The term “opportunistic” is used to describe prescribed abnormal/erratic passenger movements, for example where a passenger: runs for a train (for example arriving at the train platform just before a scheduled departure), moves erratically between boarding locations, and so on. It will be appreciated that there are substantial differences in motion attributes of core and opportunistic passengers, enabling those skilled in the art to identify and/r develop of motion-based algorithms that facilitate such categorisation.

Categorisation of “core” and “opportunistic” behaviours enables useful analysis of dwell time. For example, dwell events may be associated with a number of “core” and “opportunistic” boardings (and/or de-boardings). This may be used to reveal relationships between dwell times and passenger types. For instance, observations that higher-than-ideal dwell times are being caused by “opportunistic” behaviors may influence decisions to implement practices that reduce/inhibit certain opportunistic behaviours. This may include, for example, enforcing door closures in spite of opportunistic passenger identification and/or other physical measures. The extent to which opportunistic behaviours effect dwell times is also able to be analysed (potentially revealing compounding effects, for example where opportunistic passengers cause further delays by holding a door open or the like).

In further embodiments, other/additional forms of categorisation are implemented, based on passenger motion characteristics and/or defined passenger typologies. For example, in one embodiment the “core” and “opportunistic” categories are further separated into multiple sub-categories.

### Correlation of Dwell Event Artefacts to Maintenance Alerts

In the context of various conveyances, such as trains, certain events are automatically observed and recorded in a maintenance alert log. For example, a door failing to close, or failing to close in the “normal” manner, is typically recorded in such a log. This then triggers a maintenance process, whereby a potentially faulty door (or other piece of equipment) is serviced or scheduled for servicing.

In some embodiments, one or more dwell event artefacts are reconciled against a maintenance alert log. That is, by way of example, a prescribed motion artefact (or set of motion artefacts) identified via analysis of data derived from activity sensing units is associated is flagged as being potentially relevant to a maintenance alert log. This may include identification of a passenger blocking closure of a door. A report (or other data set) is then generated, such that the time (and optionally other details, such as location) associated with the prescribed motion artefact (or set of motion artefacts) are outputted in a form that enables reconciliation against a maintenance alert log (which may be any data source that is used to influence maintenance actions). So, for example, motion artefacts identified via dwell time-monitoring equipment (such as a passenger purposely preventing a door from closing) are made available for utilisation in reducing unnecessary maintenance (for example maintenance based on an assumption that the relevant door did not close due to faulty equipment).

### Example Application of Dwell Time Diagnostics

In some embodiments, dwell time diagnostics as described herein is applied for either or both of the following purposes:
To enable stabilising of dwell time of rail services at rail stations, so that the period of time spent for each rail service is generally similar. This allows more reliable scheduling of services.
To enable minimisation/optimisation of the dwell time of rail services at rail stations. This allows the total number of train paths, and/or total number of train services as a function of time operated on a given section of track, to be increased thereby increasing the capacity of rail services.

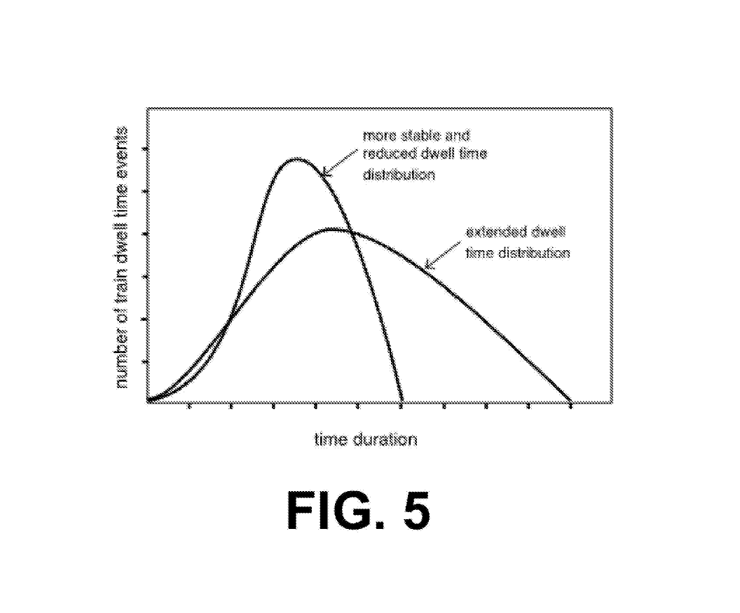

This is illustrated FIG. 5, which shows an indicative statistical distribution for train dwell time events for a service. This service has extended dwell times characterised by greater variation in the period of time train services spend stopped at station to allow passengers to board and de-board. It also shows an indicative statistical distribution for train services with less variation in the period of time spent at stations. The later enables more stable train operations than the former.

### Conclusions and Interpretation

Unless specifically stated otherwise, as apparent from the following discussions, it is appreciated that throughout the specification discussions utilizing terms such as “processing,” “computing,” “calculating,” “determining”, analysing” or the like, refer to the action and/or processes of a computer or computing system, or similar electronic computing device, that manipulate and/or transform data represented as physical, such as electronic, quantities into other data similarly represented as physical quantities.

In a similar manner, the term “processor” may refer to any device or portion of a device that processes electronic data, e.g., from registers and/or memory to transform that electronic data into other electronic data that, e.g., may be stored in registers and/or memory. A “computer” or a “computing machine” or a “computing platform” may include one or more processors.

The methodologies described herein are, in one embodiment, performable by one or more processors that accept computer-readable (also called machine-readable) code containing a set of instructions that when executed by one or more of the processors carry out at least one of the methods described herein. Any processor capable of executing a set of instructions (sequential or otherwise) that specify actions to be taken are included. Thus, one example is a typical processing system that includes one or more processors. Each processor may include one or more of a CPU, a graphics processing unit, and a programmable DSP unit. The processing system further may include a memory subsystem including main RAM and/or a static RAM, and/or ROM. A bus subsystem may be included for communicating between the components. The processing system further may be a distributed processing system with processors coupled by a network. If the processing system requires a display, such a display may be included, e.g., a liquid crystal display (LCD) or a cathode ray tube (CRT) display. If manual data entry is required, the processing system also includes an input device such as one or more of an alphanumeric input unit such as a keyboard, a pointing control device such as a mouse, and so forth. The term memory unit as used herein, if clear from the context and unless explicitly stated otherwise, also encompasses a storage system such as a disk drive unit. The processing system in some configurations may include a sound output device, and a network interface device. The memory subsystem thus includes a computer-readable carrier medium that carries computer-readable code (e.g., software) including a set of instructions to cause performing, when executed by one or more processors, one of more of the methods described herein. Note that when the method includes several elements, e.g., several steps, no ordering of such elements is implied, unless specifically stated. The software may reside in the hard disk, or may also reside, completely or at least partially, within the RAM and/or within the processor during execution thereof by the computer system. Thus, the memory and the processor also constitute computer-readable carrier medium carrying computer-readable code.

Furthermore, a computer-readable carrier medium may form, or be included in a computer program product.

In alternative embodiments, the one or more processors operate as a standalone device or may be connected, e.g., networked to other processor(s), in a networked deployment, the one or more processors may operate in the capacity of a server or a user machine in server-user network environment, or as a peer machine in a peer-to-peer or distributed network environment. The one or more processors may form a personal computer (PC), a tablet PC, a set-top box (STB), a Personal Digital Assistant (PDA), a cellular telephone, a web appliance, a network router, switch or bridge, or any machine capable of executing a set of instructions (sequential or otherwise) that specify actions to be taken by that machine. Smart phone and/or smart watch and/or electronic advertising billboards may also be used.

Note that while diagrams only show a single processor and a single memory that carries the computer-readable code, those in the art will understand that many of the components described above are included, but not explicitly shown or described in order not to obscure the inventive aspect. For example, while only a single machine is illustrated, the term “machine” shall also be taken to include any collection of machines that individually or jointly execute a set (or multiple sets) of instructions to perform any one or more of the methodologies discussed herein.

Thus, one embodiment of each of the methods described herein is in the form of a computer-readable carrier medium carrying a set of instructions, e.g., a computer program that is for execution on one or more processors, e.g., one or more processors that are part of web server arrangement. Thus, as will be appreciated by those skilled in the art, embodiments of the present invention may be embodied as a method, an apparatus such as a special purpose apparatus, an apparatus such as a data processing system, or a computer-readable carrier medium, e.g., a computer program product. The computer-readable carrier medium carries computer readable code including a set of instructions that when executed on one or more processors cause the processor or processors to implement a method. Accordingly, aspects of the present invention may take the form of a method, an entirely hardware embodiment, an entirely software embodiment or an embodiment combining software and hardware aspects. Furthermore, the present invention may take the form of carrier medium (e.g., a computer program product on a computer-readable storage medium) carrying computer-readable program code embodied in the medium.

The software may further be transmitted or received over a network via a network interface device. While the carrier medium is shown in an exemplary embodiment to be a single medium, the term “carrier medium” should be taken to include a single medium or multiple media (e.g., a centralized or distributed database, and/or associated caches and servers) that store the one or more sets of instructions. The term “carrier medium” shall also be taken to include any medium that is capable of storing, encoding or carrying a set of instructions for execution by one or more of the processors and that cause the one or more processors to perform any one or more of the methodologies of the present invention. A carrier medium may take many forms, including but not limited to, non-volatile media, volatile media, and transmission media. Non-volatile media includes, for example, optical, magnetic disks, and magneto-optical disks. Volatile media includes dynamic memory, such as main memory. Transmission media includes coaxial cables, copper wire and fiber optics, including the wires that comprise a bus subsystem. Transmission media also may also take the form of acoustic or light waves, such as those generated during radio wave and infrared data communications. For example, the term “carrier medium” shall accordingly be taken to included, but not be limited to, solid-state memories, a computer product embodied in optical and magnetic media; a medium bearing a propagated signal detectable by at least one processor of one or more processors and representing a set of instructions that, when executed, implement a method; and a transmission medium in a network bearing a propagated signal detectable by at least one processor of the one or more processors and representing the set of instructions.

It will be understood that the steps of methods discussed are performed in one embodiment by an appropriate processor (or processors) of a processing (i.e., computer) system executing instructions (computer-readable code) stored in storage. It will also be understood that the invention is not limited to any particular implementation or programming technique and that the invention may be implemented using any appropriate techniques for implementing the functionality described herein. The invention is not limited to any particular programming language or operating system.

It should be appreciated that in the above description of exemplary embodiments of the invention, various features of the invention are sometimes grouped together in a single embodiment, figure, or description thereof for the purpose of streamlining the disclosure and aiding in the understanding of one or more of the various inventive aspects. This method of disclosure, however, is not to be interpreted as reflecting an intention that the claimed invention requires more features than are expressly recited in each claim. Rather, as the following claims reflect, inventive aspects lie in less than all features of a single foregoing disclosed embodiment. Thus, the claims following the Detailed Description are hereby expressly incorporated into this Detailed Description, with each claim standing on its own as a separate embodiment of this invention.

Furthermore, while some embodiments described herein include some but not other features included in other embodiments, combinations of features of different embodiments are meant to be within the scope of the invention, and form different embodiments, as would be understood by those skilled in the art. For example, in the following claims, any of the claimed embodiments can be used in any combination.

Furthermore, some of the embodiments are described herein as a method or combination of elements of a method that can be implemented by a processor of a computer system or by other means of carrying out the function. Thus, a processor with the necessary instructions for carrying out such a method or element of a method forms a means for carrying out the method or element of a method. Furthermore, an element described herein of an apparatus embodiment is an example of a means for carrying out the function performed by the element for the purpose of carrying out the invention.

In the description provided herein, numerous specific details are set forth. However, it is understood that embodiments of the invention may be practiced without these specific details. In other instances, well-known methods, structures and techniques have not been shown in detail in order not to obscure an understanding of this description.

Similarly, it is to be noticed that the term coupled, when used in the claims, should not be interpreted as being limited to direct connections only. The terms “coupled” and “connected,” along with their derivatives, may be used. It should be understood that these terms are not intended as synonyms for each other. Thus, the scope of the expression a device A coupled to a device B should not be limited to devices or systems wherein an output of device A is directly connected to an input of device B. It means that there exists a path between an output of A and an input of B which may be a path including other devices or means. “Coupled” may mean that two or more elements are either in direct physical or electrical contact, or that two or more elements are not in direct contact with each other but yet still co-operate or interact with each other.

Thus, while there has been described what are believed to be the preferred embodiments of the invention, those skilled in the art will recognize that other and further modifications may be made thereto without departing from the spirit of the invention, and it is intended to claim all such changes and modifications as falling within the scope of the invention. For example, any formulas given above are merely representative of procedures that may be used. Functionality may be added or deleted from the block diagrams and operations may be interchanged among functional blocks. Steps may be added or deleted to methods described within the scope of the present invention.

1. A computer implemented method for analysing dwell time in respect of a human conveyance, the method including:
receiving data derived from one or more activity sensing units, wherein the activity sensing units include one or more sensors configured to provide three dimensional depth data;
processing the received data based on a set of one or more processing algorithms, thereby to define dwell event data, including dwell event data derived from processing of data representative of movement of objects in three dimensions derived from the one or more sensors configured to provide three dimensional depth data;
updating a dwell event database, thereby to store the dwell event data; and
executing a reporting module that is configured to provide report data derived from the dwell event database.

2. A method according to claim 1 including:
processing the received data based on a set of one or more processing algorithms, thereby to identify dwell event artefacts, wherein each dwell event artefact relates to an activity observed in the received data, including one or more dwell event artefacts identified using processing of data representative of movement of objects in three dimensions derived from the one or more sensors configured to provide three dimensional depth data;
processing the dwell event artefacts thereby to define one or more dwell events, including at least one dwell event defined based a dwell event artefact identified using processing of data representative of movement of objects in three dimensions derived from the one or more sensors configured to provide three dimensional depth data;
updating a dwell event database, thereby to store data associates each set of dwell event artefacts with its associated dwell event; and
executing a reporting module that is configured to provide report data derived from the dwell event database.

3. A method according to claim 1 or claim 2 wherein the report data includes report data representative of representative of either or both of: (i) core passenger movements; and (ii) opportunistic passenger movements.

4. A method according to claim 2 wherein the dwell event artefacts include one or more dwell event artefacts derived from data representing passenger activity and/or timing data associated with passenger activity, wherein the data representing passenger activity is derived from the one or more sensors configured to provide three dimensional depth data.

5. A method according to claim 4 wherein the one or more dwell event artefacts derived from data representing passenger activity include one or more dwell event artefacts representative of either or both of (i) core passenger movements; and (ii) opportunistic passenger movements.

6. A method according to claim 4 wherein passenger activity includes any one or more of: passenger movement; passenger demographic categorisation; passenger density; passenger throughput; passenger movement directions; and abnormal passenger behaviours.

7. A method according to claim 2 wherein processing the dwell event artefacts thereby to define one or more dwell events includes: processing the dwell event artefacts thereby to define a given dwell event by determining a set of dwell event artefacts that collectively define that dwell event.

8. A method according to claim 2 wherein the dwell event artefacts include data representing conveyance activity and/or timing data associated with conveyance activity, including one or more of: conveyance position; conveyance velocity; conveyance door status; conveyance door movement characteristics; and conveyance visual attributes.

9. A method according to claim 1 including: (i) identifying one or more measures configured to optimise dwell time; and (ii) determining a conveyance scheduling protocol based on the optimised dwell time.

10. A method according to claim 1 wherein one or more dwell event artefacts are reconciled against a maintenance alert log.

11. A computer implemented method for analysing dwell time in respect of a human conveyance, the method including:
receiving data derived from one or more activity sensing units;
processing the received data based on a set of one or more processing algorithms, thereby to identify dwell event data;
updating a dwell event database based on the dwell event data; and
executing a reporting module that is configured to provide report data derived from the dwell event database.

12. A method according to claim 11 including:
processing the received data based on a set of one or more processing algorithms, thereby to identify dwell event artefacts, wherein each dwell event artefact relates to an activity observed in the received data;
processing the dwell event artefacts thereby to define one or more dwell events;
updating a dwell event database, thereby to store data that relates each set of dwell event artefacts with its associated dwell event; and
executing a reporting module that is configured to provide report data derived from the dwell event database.

13. A method according to claim 12 including, for each dwell event, determining a set of dwell event artefacts that are associated with that dwell event.

14. A method according to claim 12 wherein processing the dwell event artefacts thereby to define one or more dwell events includes: processing the dwell event artefacts thereby to define a given dwell event by determining a set of dwell event artefacts that collectively define that dwell event.

15. A method according to claim 14 wherein the set of dwell event artefacts that collectively define that dwell event include: a first dwell event artefact that defines a start time for the dwell event; and a second dwell event artefact that defines a finish time for the dwell event.

16. A method according to claim 12 including a subsequent step of associating one or more further dwell event artefacts with a defined dwell event.

17. A method according to claim 12 wherein the set of one or more processing algorithms include algorithms configured to perform any one or more of the following: (i) identify presence and/or movement of an object having defined characteristics; (ii) categorise an object based on attributes of its activity; and (iii) identify prescribed action types based on activities of an object.

18. A method according to claim 12 wherein determining a set of dwell event artefacts that are (Original) associated with a given dwell event includes applying a set of dwell time processing rules.

19. A method according to claim 12 wherein the one or more activity sensing devices are configured to sense movement of objects in three dimensions.

20-27. (canceled)

28. A computer implemented method for analysing dwell time in respect of an object, the method including:
receiving data derived from one or more activity sensing units;
maintaining access to a repository of dwell-time processing rules;
processing the received data based on one or more of the dwell time processing rules, thereby to:
define individual dwell events;
for each dwell event, define a set of dwell event artefacts; and
update a dwell event database, thereby to store data that associates each set of dwell event artefacts with a particular dwell event; and
execute a reporting module that is configured to provide report data derived from the dwell event database.

29-31. (canceled)
